(19) United States
(12) Patent Application Publication
(10) Pub. No.: US 2015/0149386 A1
(43) Pub. Date: May 28, 2015

(54) Piggy Bank Account/Penny Bank Account/PBA

(71) Applicant: Ali Reza khodavardad, Woodland Hills, CA (US)

(72) Inventor: Ali Reza khodavardad, Woodland Hills, CA (US)

(21) Appl. No.: 14/551,083

(22) Filed: Nov. 24, 2014

Related U.S. Application Data
(60) Provisional application No. 61/908,086, filed on Nov. 23, 2013.

(51) Int. Cl. G06Q 40/06; G06Q 20/34

(52) U.S. Cl. CPC G06Q 40/06; G06Q 40/02; G06Q 20/355
USPC 705/36 R

(57) ABSTRACT

Piggy bank account or penny bank account(PBA) is a new model of interne banking business that do like a merchant to charging assigned debit and credit cards to feed a PBA account that is saving and retirement account for customers. PBA is a system and methods that track expenses of customers on assigned cards (credit and debit) through an automated special web connection with bank card issuer's website to pull out the transaction information. PBA charge assigned cards according to preselected contribution plans. PBA provide highly convenience method for people who want to save and invest with each purchase.

### CROSS-REFERENCE TO RELATED APPLICATIONS

This application is a non-provisional of and claims the benefit of the filing date of Provisional Application 61/908,086, filed on Nov. 23, 2013.

### BACKGROUND OF THE INVENTION

The present invention is in the technical field of bank. More particularly, the present invention is in the field of internet bank. More particularly, the present invention is in the field of retirement plan and saving account.

Back to many years ago, some people try to saving some percent of their income for rainy days, emergency needs, and retirement when they can't work. Piggy bank was one of oldest reservoir for saved money. New world , new banking systems, and progress in financial science made many type of saving accounts, retirement plans, and investment strategies to solve this human problem. Nowadays with all of these saving accounts and different type of retirement plans (IRA/Roth IRA/401K/pension plan), but many of Americans don't have enough money for financial emergencies and retirement. Roughly three-quarters of Americans are living paycheck-to-paycheck, with little or no emergency savings.

The reason of this problem is habits of people to spending money. Americans are good at spending but lousy at saving. New world's economy encourages people to spending money, more and more for different stuff from foods to new technology. To keep some money for rainy days, people need to set up saving habit in their brain. Most of actions we do every day are habits not a decision. Make a good habit and break of bad habits are very difficult. For example exercise is a good habit and addiction is a bad habit. Today we knows neurological pathway of habits in brain that forms in unconscious part of brain. Habit formation is the process by which new behaviors become automatic.

Any retirement plan or saving account to be popular, successful, and works for most of people, must be feed unconsciously. Everybody knows about benefit of exercise and saving as good habits, but most of people got excuse to don't do that. I believe put back some money for rainy days; more depend to saving habits than level of income. If it's not impossible, it would be so difficult to making a good habit in most of people. All of people have money spending habit because it's necessary for life, like eating and drinking. Most of transactions (more than 70%) at the point of sales were made by plastic cards and are cashless.

PBA is a revolutionary method or process in retirement plan and saving account which joined saving and investment with spending. So because everybody has to spend, unconsciously deposit some pennies in PBA. With PBA anybody can keep the change and small percent of transaction value in a saving and investment account. Most Americans probably inclined to pay everyone else first, whether it's their landlord, utility bills, their grocer, and loan payments. PBA is the best and may be only way to pay yourself first, because PBA is automated, unconscious, seamless, and joined with spending. Indeed you open PBA consciously and PBA get you rich unconsciously.

Many of banks like Bank of America that have Keep the Change saving program, Wells Fargo that have Way2Save saving account program, and United Community Bank that have swipe and save service, and programs like Round Me Up and Every Penny Counts that already do round up pennies and transfer these pennies from checking to saving accounts. PBA is different from all these programs because PBA do like a merchant and charge assigned cards (Both type of cards, debit and credit) through an automated and unconscious system and there is no intermediary between customer and PBA. All other similar programs only transfer up rounded pennies and some percent of transaction from checking to saving account (only applicable for debit cards) and each bank can do these programs only for their self issued debit cards. With PBA the customers can assign all wallet cards (debit and credit) to one account, no matter which bank issued those cards. With PBA the customers can pay, save, invest, and go.

### SUMMARY OF THE INVENTION

New online bank account (piggy bank account/penny bank account/PBA) that feed through automated and unconscious deposit of up rounded pennies (change) and/or some authorized percent (1-10%) of transaction value with each swiping card or online electronic transaction (use Credit/Debit). The customers open PBA account online, and assign wallet cards to this account. Best option is to assign all plastic cards (debit and credit) in the wallet or all cards in digital wallet like Google wallet and Apple Pay to feed PBA account. (PBA system has potentiality to assign all checking accounts, saving accounts, PayPal, and Alipay to be sources of feeding for PBA account). PBA track all personal financial expenses on assigned cards and charging assigned cards like a merchant according to selected contribution plan. PBA platform capture transaction information through an automated special web connection with bank card issuer's website. Total deposit in PBA divide between different investment and saving boxes. The customers can use PBA debit card for balance in saving boxes. Access to investment boxes for retirement is restricted according to terms and conditions.

The preferred embodiment of the present invention is directed to a method of providing an account with multiple boxes that feeds in different way with charging assigned cards like a merchant. In this way customers authorized PBA to charge assigned cards according to selected contribution plans.

In another embodiment of present invention is directed to a method of tracking expenses on assigned cards through a special web connection with bank card issuer's website. The customers with release of cards information including user name and password of assigned cards let PBA to automatically pull out transactions information of assigned cards.

Another embodiment of present invention is directed to other methods of tracking expenses on assigned cards through manual download of transactions history by customers to import into PBA account, sending transactions information by piggy bank snapshot, sending transactions information by piggy bank text, and sending transactions information through PBA website and App. (All these methods would be applicable if the customers are not comfortable to release user name and password of assigned cards)

One important aspect of present invention is directed to a method of providing an account that user can assigns all wallet cards (both debit and credit), no matter which bank issued these cards. Because PBA can start as soon as every person get first debit or credit card, and all cards can assign to PBA, it can have fast growing for long term.

### BRIEF DESCRIPTION OF THE DRAWINGS

FIG. 1 is a perspective view of piggy bank account processing that shows how PBA works.

### DETAILED DESCRIPTION OF THE INVENTION

PBA is a new web based piggy bank account that act through interne. PBA is a great new retirement plan to put away some pennies in your account for rainy days. PBA cause some affordable pennies go away from your vision to invest and save in your retirement account. Because PBA joined with spending by plastic cards, it can grow for long times. As soon as a person gets plastic cards (credit/debit) he or she can open PBA. Indeed PBA is a new retirement account that feed differently and makes a peace of mind for our community. With PBA account, plastic cards (debit and credit) are tools not only for paying transactions but also for saving and investment. Mechanism of action of PBA is different with all previous retirement plans and saving accounts.

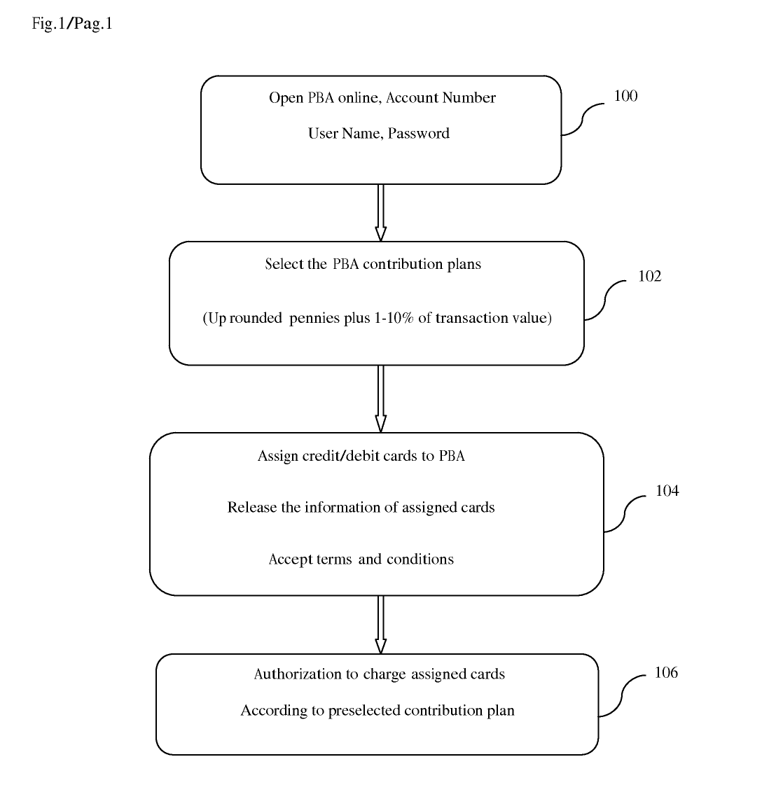

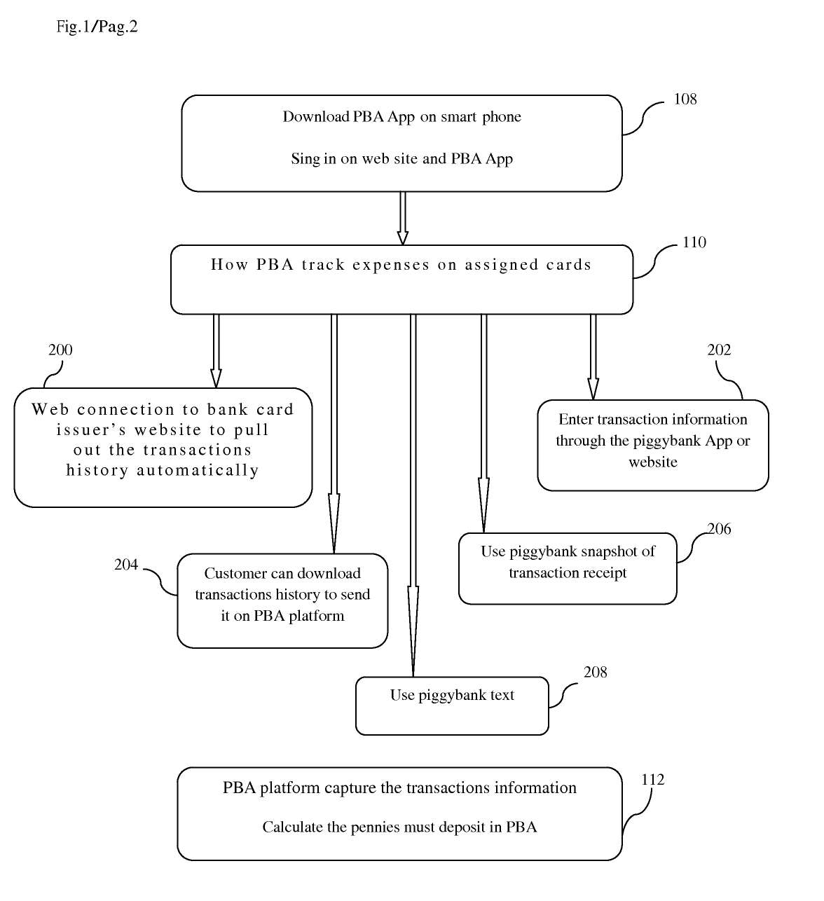

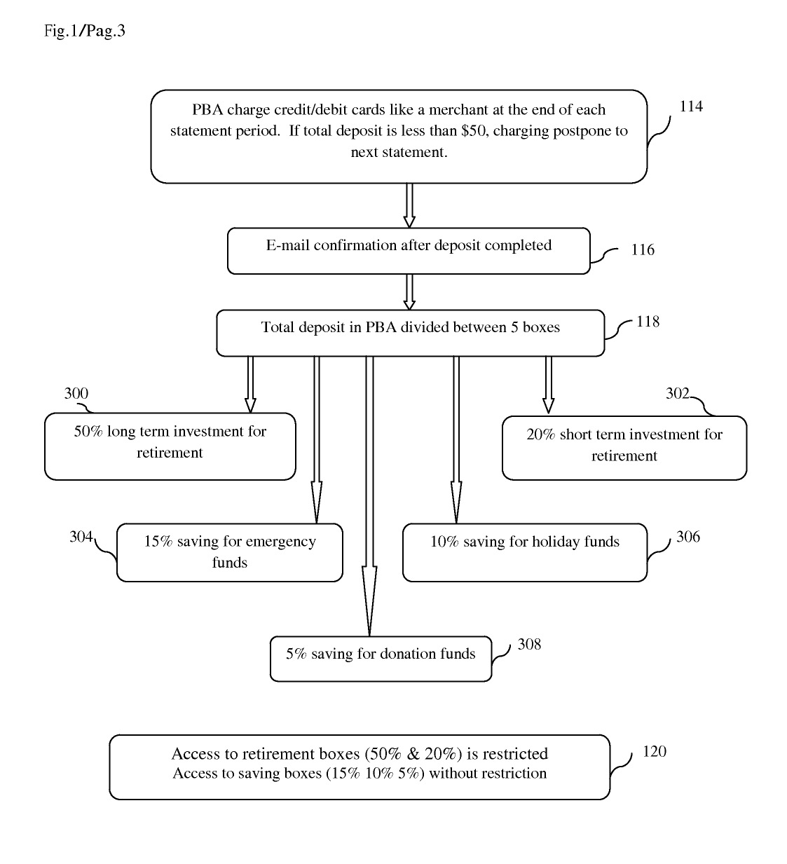

To start PBA, as soon as people get credit or debit cards are able to open online PBA account and start to make their retirement. As showed in diagram FIG. 1/Page.1 (100) people can open PBA with $1.00 and then select the different contribution plans, up rounded pennies plus 1-10% of transaction value (102). PBA has different plans and there are options to select one plan for all assigned cards or different plans for different assigned cards. After accept terms and conditions, assignment of cards to feed PBA, and release the information of cards including user name and password of assigned cards (104), PBA account is ready to use. For each assigned card one time authorization to charge that card by PBA is necessary (106). There would be options to change the contribution plans or stop feeding PBA by assigned cards.

After PBA become active, selected plans of PBA would be active in PBA calculator software (this software designed to calculate feeding pennies of PBA according to per-selected contribution plans). Access to PBA would be online by website or PBA app (108). The customers will receive PBA debit card (Visa or Master) that let them spend their PBA saving boxes balance everywhere or withdraw cash at ATMs. PBA can send and receive money from other bank accounts. There is two type of balance in PBA account, available (saving boxes) and unavailable (investment boxes) balance.

To start charging assigned cards, PBA software needs transactions information of all assigned cards (110). PBA uses Special Web Connection to access these information (200), the same system that use by many personal financial management software like www.mint.com or Quicken. Other way is downloading transaction history directly through bank's website and import into PBA by the customers (204). The customers can submit information of transaction by other ways. These ways including but not limited to: 1. piggy bank snapshot of receipt (206) and submit to PBA 2. Through PBA app or website to enter transaction information (202) 3. Use piggy bank text (208) to send information.

After PBA platform capture information and calculate pennies should deposit in PBA accounts (112), it will show as pending pennies in PBA account. PBA will charge credit and debit cards like a merchant (114) at the end of each PBA statement period if total pending pennies be at least $50.00 or more. If total pending pennies is less than $50.00 for each statement period, charging credit or debit card postpone to next statement period. After deposits of pending pennies are completed to PBA, E-mail confirmation will send to customer (116).

The main difference of PBA with other retirement plans is feeding way of PBA , continuous feeding of PBA, joined with spending, more chance to be a habit, affordable for everyone, and combined retirement plan and saving in same account with different PBA boxes (118). There are five boxes with different access rules (120). Most of pennies go to retirement boxes (300) and (302). Other boxes (304) (306) (308) feed with different proportions.

In one example, let say John has two debit cards and three credit cards; he opened a PBA account and assigned all his cards to this account, and authorized PBA to charge his cards for up rounded pennies and 5% of transactions value. Automated tracking of his cards during May 2014, showed following transactions on each card:
1. BOA debit card transactions: $1600.00(for rent), $133.60 (Verizon bill), 54.99 (internes)
2. Wells Fargo debit card transactions: $225.50 (online shopping), $44.30 (restaurant), $46.60 (gas), $90.00 (Insurance)
3. Chase credit cards transactions: $38.70 (gas), $8.60 (MacDonald), $6.30 (Starbucks), $66.90 (Grocery)
4. Citi credit card: 85.60 (Wal-Mart), $25.80 (Grocery), $12.40 (Subway), 125.00 (Macy's),
5. Ame Ex credit card: $150.74 (Costco), $38.40 (gas), $320.00 (airline ticket), 130.50 (Costco), 110.00 (cable), $330.00 (Hotel)

PBA platform calculation according to contribution plan would be:
1. BOA debit card total charge : 80.00+7.10+2.76=$89.86
2. Wells Fargo debit card total charge: 11.80+2.95+2.75+4.5=$22.00
3. Chase credit card total charge: 2.25+0.85+1.05+3.45=$7.60
4. Citi credit card total charge: 4.70+1.3+1.25+6.25=$13.50
5. Ame Ex credit card: 7.81+2.55+16+7.05+5.5+16.5=$55.41

PBA will charge BOA debit card $89.86, and Ame Ex credit card $55.41 as a merchant

PBA postpone charging of Wells Fargo debit card, Chase credit card, and Citi credit card to next statement period because total contribution plan on each card is less than $50.00.

(PBA cover merchant fee and don't touch principle of money. PBA has a secret sauce to financial sustainability of this business)

Total pennies goes to PBA account for May 2014 would be $89.86+$55.41=$145.27

This total deposit divides between five boxes:
1. $72.63 in long term investment box
2. $29.05 in short term investment box
3. $21.79 in emergency fund box
4. $14.50 in holiday fund box
5. $7.30 in donation box

John has access to funds in emergency box, holiday box, and donation box through PBA debit card. Access to investment boxes is according to terms and conditions.

What is claimed is:

1. A new model of internet banking business which named piggy bank account or penny bank account or PBA comprising following steps:
Opening an PBA account online,
select contribution plan to feed PBA,
assign debit and credit cards to PBA,
release information of assigned cards (including user and password of cards),
accept terms and conditions and give authorization to charge assigned cards,
customer will receive a PBA debit card (Visa or Master),
PBA track all expenses on assigned cards through a special web connection system with bank card issuer's website,
or customers inform PBA through download transaction history of assigned cards,
or through piggy bank snapshot of receipt,
or through piggy bank text,
or through piggy bank App or website,
PBA platform calculate pennies according to contribution plan,
PBA charge assigned debit and credit cards like a merchant account,
Customers will receive Email confirmation after deposit completed,
total deposit in PBA divide between investment boxes and saving boxes.

2. The method of claim 1, further consisting of: PBA is an internet account with different saving and investment boxes for retirement that feeds through joining with spending of assigned cards (debit and credit), and charging assigned cards (debit and credit) according to selected contribution plan like a merchant.

3. The method of claim 1, wherein said select contribution plan to feed PBA.

4. The method of claim 1, wherein said assign debit and credit cards to PBA and release of information of assigned cards (including user and password of cards).

5. The method of claim 1, wherein said PBA track all expenses on assigned cards through a special web connection system with bank card issuer's website.

6. The method of claim 1, wherein said customers inform PBA through download transaction history of assigned cards.

7. The method of claim 1, wherein said through piggy bank snapshot of receipt

8. The method of claim 1, wherein said through piggy bank text.

9. The method of claim 1, wherein said through piggy bank App or website.

10. The method of claim 1, wherein said PBA platform calculate pennies according to contribution plan.

11. The method of claim 1, wherein said PBA charge assigned debit and credit cards like a merchant account.

12. The method of claim 1, wherein said total deposit in PBA divide between investment boxes and saving boxes.

13. PBA system has potentiality to assign all checking accounts, saving accounts, PayPal, and Alipay to be sources of feeding for PBA account.
